(19) United States
(12) Patent Application Publication
(10) Pub. No.: US 2012/0072850 A1
(43) Pub. Date: Mar. 22, 2012

(54) WEB PAGE BEHAVIOR ENHANCEMENT CONTROLS

(75) Inventors: Eran Megiddo, Bellevue, WA (US); Daniel Battagin, Bellevue, WA (US); Lawrence Waldman, Seattle, WA (US); Shahar Prish, Redmond, WA (US)

(73) Assignee: Microsoft Corporation, Redmond, WA (US)

(21) Appl. No.: 12/887,003

(22) Filed: Sep. 21, 2010

(51) Int. Cl. G06F 3/01; G06F 15/16

(52) U.S. Cl. 715/745

(57) ABSTRACT

A web page behavior enhancement (WPBE) control element is provided on a rendered web page enabling a user to perform actions on at least a portion of the web page content such as customizing, editing, sharing, analyzing, exporting, and/or annotating the content. The processed content may be presented on the original web page, on a locally stored version of the web page, or archived for subsequent use, where any changes to the original web page content may be tracked and the user notified about the changes. The WPBE control element(s) may be embedded into the web page at the source web application or at the local browser based on factors like web application capabilities, browser capabilities, user preferences, usage pattern, and comparable ones.

### BACKGROUND

Web applications provide a wide variety of services and data to users over networks. Data is collected, processed, and stored in different locations. Web applications retrieve that data, format it for presentation, and provide it to browsing applications on client devices for rendering web pages. Some web pages may be static, where the data is non-interactive. Others may provide some interactivity such as additional information through links or activation of web-based modules. In general, however, web pages present data in a format and amount that is decided by the web page author.

Data in conventional web pages generally has limited interactivity as defined by the web page author restricting its usefulness to users. Even if the page author explicitly provides export or “data feed” functionality for the content, users have to perform several relatively complicated operation to access and process the data. Additionally, providing one presentation of the data on the web page itself and providing a richer experience with implied data (data available to the web page author but not displayed to users) to the user is relatively a difficult undertaking.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing a web page behavior enhancement (WPBE) control element on a rendered web page that enables a user to perform actions on at least a portion of the web page content such as customizing, sharing, editing, analyzing, exporting, and/or annotating the content. The processed content may be presented on the original web page stored at a server, on a locally stored version (stored at a client) of the web page, or archived for subsequent use, where any changes to the original web page content may be tracked and the user notified about the changes. The WPBE control element(s) may be embedded into the web page by the source web application or at the local browser based on factors like, browser capabilities, user preferences, usage pattern, and comparable ones.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example web page multiple WPBE control elements;

FIG. 2 illustrates two web pages with different example presentations of available actions associated with a WPBE control element;

FIG. 3 illustrates another web page with an example user interface for performing a selected action associated with the WPBE control element;

FIG. 4 illustrates a further web page, where the rendered content is annotated with a chart using a WPBE control element and an associated action;

FIG. 5 illustrates yet another web page, where the rendered content is transformed into a spreadsheet using a WPBE control element and an associated action;

FIG. 6 illustrates major components in a system providing web page enhancement through a WPBE control element and a WPBE control engine;

FIG. 7 illustrates operations of a WPBE control engine and its interactions with web page content;

FIG. 8 is a networked environment, where a system according to embodiments may be implemented;

FIG. 9 is a block diagram of an example computing operating environment, where embodiments may be implemented; and

FIG. 10 illustrates a logic flow diagram for a process of providing web page behavior enhancement control according to embodiments.

### DETAILED DESCRIPTION

As briefly described above, a web page behavior enhancement (WPBE) control element may be provided on a rendered web page enabling a user to perform actions on at least a portion of the web page content such as customizing, sharing, editing, analyzing, exporting, and/or annotating the content. The processed content may be presented on the original web page stored at a server, on a locally stored version at a client of the web page, or archived for subsequent use, where any changes to the original web page content may be tracked and the user notified about the changes. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable storage media.

Throughout this specification, the term “platform” may be a combination of software and hardware components for web pages and data presentation through web pages. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

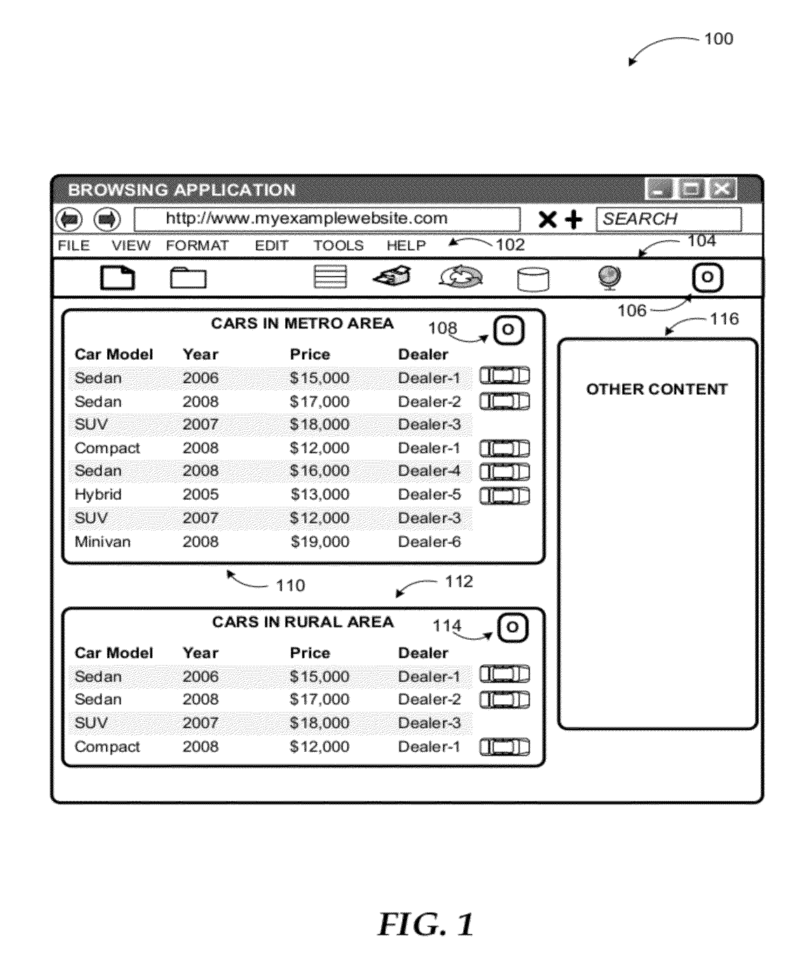

FIG. 1 illustrates an example web page multiple WPBE control elements. Example web page 100 includes standard web page elements such as menu items 102, graphical controls 104, and three content portions 110, 112, and 116. Interactivity with data presented on the web page 100 is generally limited to the boundaries set by the author of the web page (or the web application providing the web page). For example, content portion 110 presents a list of cars, their years of manufacture, prices, etc. The web page may provide additional information through links on some (or all) of the data, but the user viewing the page is limited to the format and configuration of the list. Furthermore, the user is unable to view further analyses of the data in form of results, other tables, or charts, cannot modify/sort/filter/format individual items on the list or annotate the data unless the functionality is provided by the author of the web page.

A web page according to embodiments may include one or more WPBE control elements (106, 108, and 114), which enable the user to perform various actions on the presented data and other data (e.g. implied data that is available to or from the web application presenting the web page but not displayed or related data that is stored in other locations). WPBE control element 106 is an example control element that is associated with the entire web page. Thus, actions provided through the WPBE control element 106 are applicable to the entire web page. WPBE control elements 108 and 114 are associated with content portions 110 and 112, respectively. Thus, these elements provide actions applicable to their respective content portions. While the actions provided by the WPBE control elements may be distinct for each content portion, they may also be the same.

The web page 100 may typically be rendered by a browsing application on a client device, which may include any computing device such as a personal computer, a laptop, a mobile device such as a smart phone, a server, a vehicle mount computing device, and others that are connected to a web server through a network.

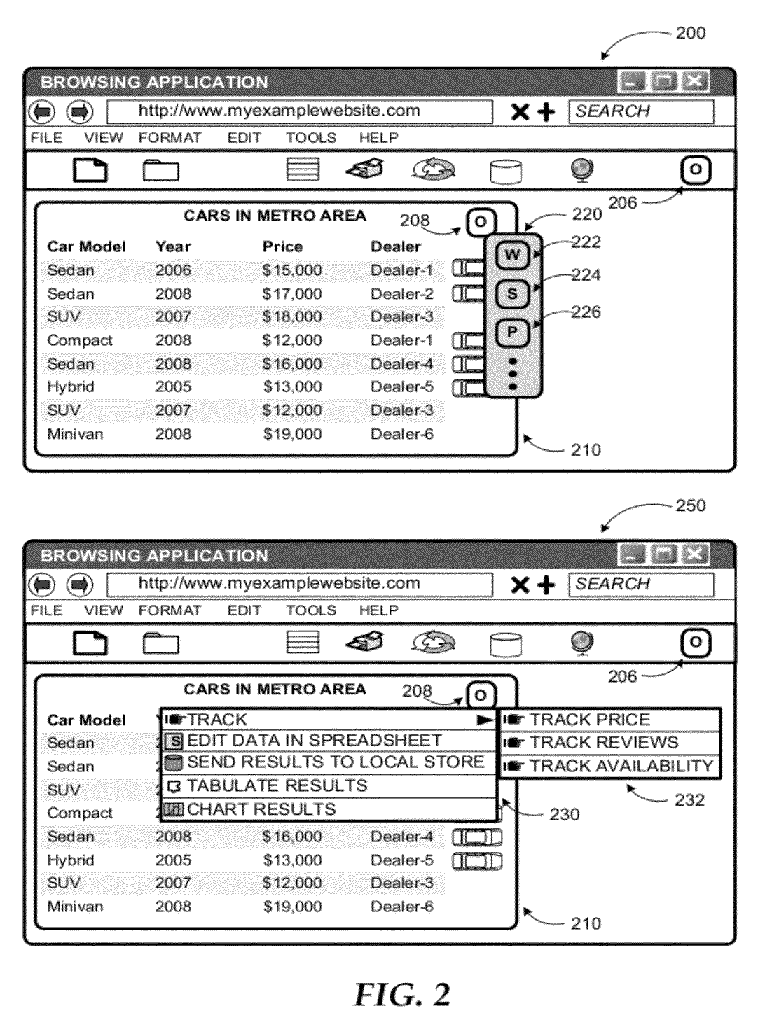

FIG. 2 illustrates two web pages with different example presentations of available actions associated with a WPBE control element. Example web page 200 illustrates content portion 210 similar to one of the content portions of web page 100 with the list of cars. Web page 200 also includes a WPBE control element 206 for the entire page and WPBE control element 208 for content portion 210.

Upon activation of WPBE control element 208, a list (textual, graphical, or combination) of available actions 220 may be provided to the user. For example, the list of available actions 220 may include icons for various applications through which the content may be displayed, edited, customized, analyzed, etc. Examples of such applications may include word processing application 222, spreadsheet application 224, and presentation application 226. Other examples of applications may include content aggregation applications and similar ones. These applications may be local, web-based, or embedded.

Upon selection of one of the applications, the content may be presented in a user interface associated with the selected application presenting the user with a richer/more interactive representation of the content in place on the rendered web page 200 or on a separate user interface. For example, a Hypertext Markup Language (HTML) table may be replaced with a spreadsheet table allowing the user to sort, filter, format, analyze, and chart the displayed data, among other things. Additionally, the availability of these functionalities may be controlled by the web page author.

Second example web page 250 illustrates another approach in providing the user with available actions. In this scenario, a dropdown or hover-on menu 230 of available actions may be provided in response to activation of WPBE control element 208. One or more additional levels of menus (e.g. menu 232) may be displayed in response selection of one of the items on the primary menu. Of course, other forms of presentation such as audio may also be employed in presenting the user with available actions.

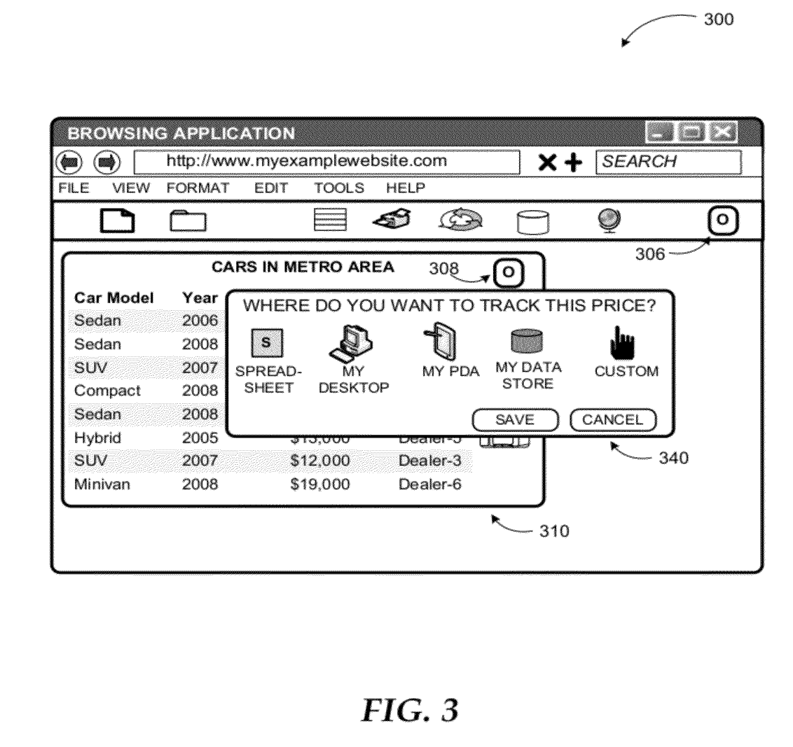

FIG. 3 illustrates another web page with an example user interface for performing a selected action associated with the WPBE control element. As shown on example web page 300 with WPBE control element 306 for the entire page and WPBE control element 308 for content portion 310, a new user interface 340 may be presented over the web page upon selection of an action by the user. In this example, the user may have selected to track the prices in the displayed list of cars.

The user interface 340 presents options of forwarding the tracking information to the user such as to a spreadsheet, user's desktop, user's personal digital assistant (PDA) or phone, a data store, or a custom defined destination. The presented actions on the primary menus of FIG. 2 as well as the items on secondary menus (or user interfaces) may be determined based on capabilities of the web application presenting the web page, capabilities of the user's local browser application or system, and/or user's preferences/usage history.

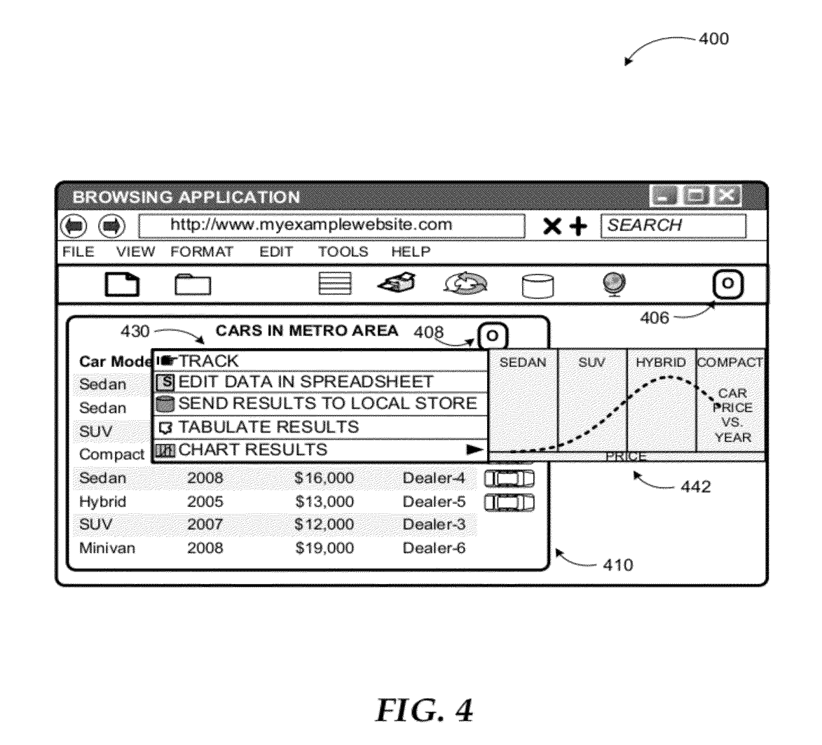

FIG. 4 illustrates a further web page, where the rendered content is annotated with a chart using a WPBE control element and an associated action. Example web page 400 is similar to web pages 200 or 300 with WPBE control element 406 for the entire page and WPBE control element 408 for content portion 410.

Upon activation of WPBE control element 408, menu 430 of available actions is displayed to the user, who selects or hovers over a menu choice for “chart results” action and receives a preview of the action. In response, a chart 442 of the data in content portion 410 is displayed on the web page. As discussed previously, the chart may also be presented on a separate application user interface (e.g. a charting application). In the former case, the modified web page may be stored locally. The changes may also be persisted such that when the user visits the same page, the charting option or other web page modification as illustrated in previous examples is presented to the user automatically enhancing the user's web page experience.

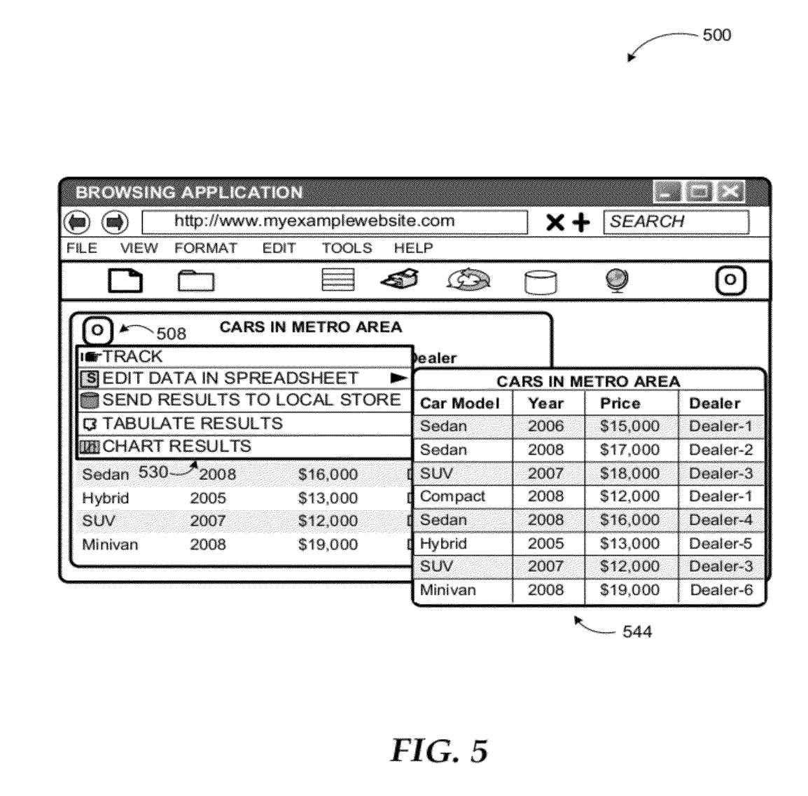

FIG. 5 illustrates yet another web page, where the rendered content is transformed into a spreadsheet using a WPBE control element and an associated action. Web page 500 illustrates another example usage of a WPBE control element (508) according to some embodiments. In the illustrated scenario, user has selected “edit data in spreadsheet” action from menu 530, which results in display of spreadsheet 544 containing the same data as on the web page.

According to other embodiments, spreadsheet 544 may include additional data such as implied data that is available at the web application presenting the web page, but not displayed. The spreadsheet may include this related data, which may be retrieved by the WPBE control engine from a data source associated with the web application. For example, technical specifications of each car on the list may be retrieved and displayed. The user may edit, format, sort, analyze, and perform other actions on the data displayed on spreadsheet 544. The modified (or customized) data may be stored or archived for further interaction by the user. If any data items change at the source (web application or data source), the user may be notified or the modified data updated automatically.

In a system according to embodiments, the above discussed functionality may be added to a web page with or without involvement of the author of the original web page. Furthermore, the additional functionality enhancing the user's web page experience may be customized based on the user's capabilities/preferences/usage pattern. Moreover, the experience of multiple people with the content of the same web page may be exposed to other users suggesting interesting and enjoyable experiences automatically. For example, the original web page may not include a chart, but a particular chart created by one user may be preferred by other users as well. The system may provide the chart as if it was part of the original web page to the other users without a change by the author of the web page.

The example user interface elements and interactions discussed in FIG. 1 through FIG. 5 are for illustration purposes only and do not constitute a limitation on embodiments. Web page behavior enhancement controls may be implemented with other user interfaces, interface elements, presentations, and configurations using the principles described herein.

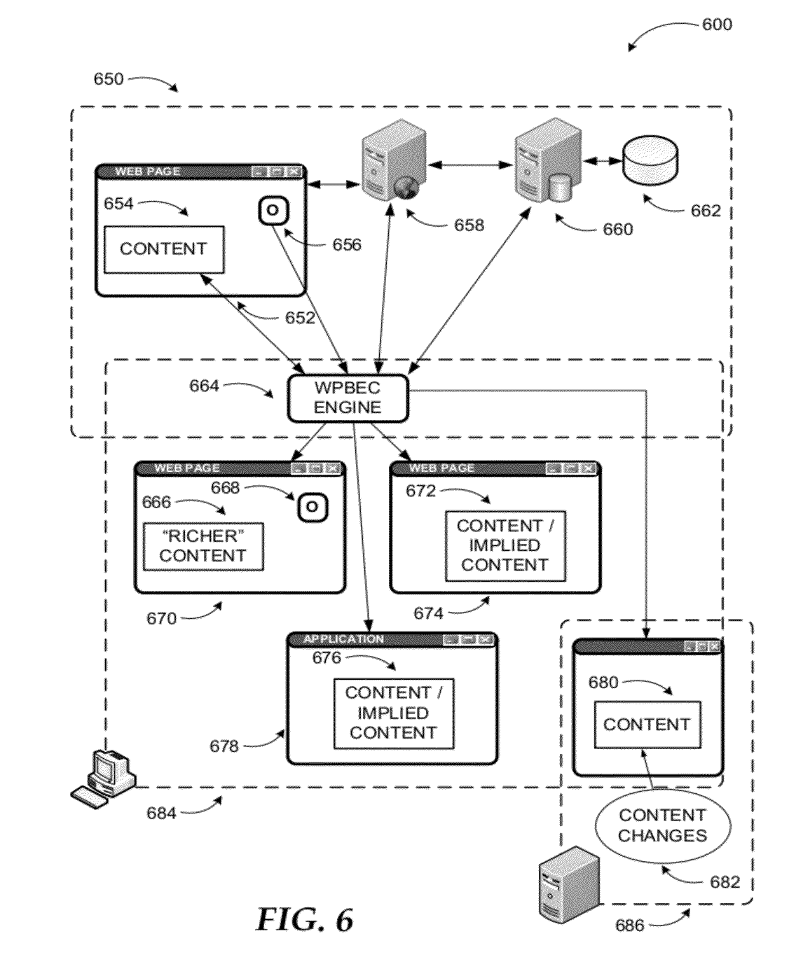

FIG. 6 illustrates major components in a system providing web page enhancement through a WPBE control element and a WPBE control engine. As shown in diagram 600, a service according to embodiments may include three distinct systems: web service 650 providing the web page 652 with content 654 and WPBE control element 656, client 684 rendering the web page to the user, and a storage service 686 for storing local version(s) of the modified web page content 680 and the change 682 for client 684.

A web application executed on web server 658 may interact with data store 663 through database server 660 retrieving data for the web page 652. WPBE control engine 664 may be executed as part of the web service 650 or client 684 and detect activation of WPBE control element 656, which may be embedded into the web page 652 at the web service 650 or by the client 684. Receiving published content data from web page 652, implied content data from web server 658, and related data from database server 660, WPBE control engine 664 may enable rendering of web page 670 with richer content 666 and WPBE control element 668 at client 684. WPBE control engine 664 may also enable rendering of web page 674 with published and/or implied content through a browser at client 684 or application user interface 678 with published and/or implied content 676 at client 684. WPBE control engine 664 may also enable archiving or copying of content 680 at storage service 686 and update the stored content with changes 682 from the original web page.

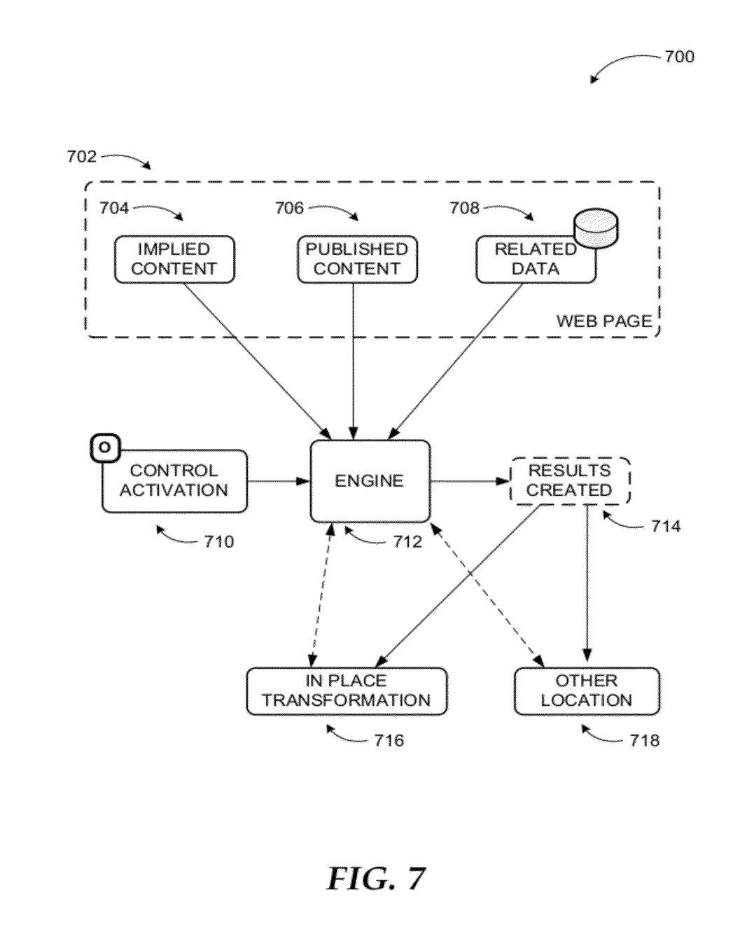

FIG. 7 illustrates operations of a WPBE control engine and its interactions with web page content. Diagram 700 summarizes the transformation of web page content in a system according to embodiments.

Upon detecting activation of a WPBE control element (710), WPBE control engine 712—which may control one or more WPBE control elements—may receive published content 706, implied content 704, and/or related data 708 associated with web page 702. The received content may be processed according to user requested action(s) as discussed previously and results created (714). In coordination with WPBE control engine 712, the created results may be presented to a user through in place transformation 716 (e.g. sorting or reformatting of displayed data) or transformation at another location 718. The latter may include storing of the original or modified web page (copy of the web page), updating of stored data, or presentation of the transformed data through an application user interface other than the browser.

The example systems and interactions discussed in FIG. 6 and FIG. 7 are for illustration purposes only and do not constitute a limitation on embodiments. Web page behavior enhancement controls may be implemented with other components, interactions, data processing/storage methods, and configurations using the principles described herein.

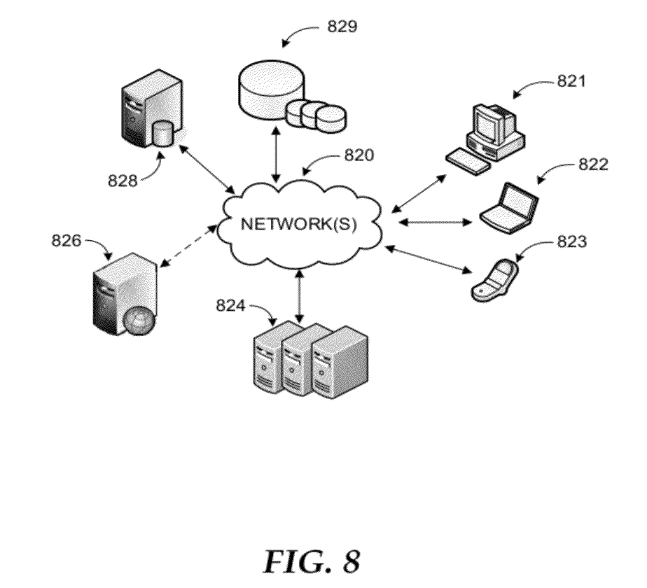

FIG. 8 is an example networked environment, where embodiments may be implemented. A platform providing web page behavior control elements and associated actions may be implemented via software executed over one or more servers 824 or a single server (e.g. web server) 826 such as a hosted service. The platform may communicate with client applications on individual computing devices such as a smart phone 823, a laptop computer 822, or desktop computer 821 (client devices') through network(s) 820.

As discussed above, one or more WPBE control elements may be embedded on web pages by the author or by a local browser on the client devices 821-823. Upon activation, the WPBE control element(s) may present a list of available actions to the user, and upon user selection process the content of the rendered web page enabling the user to customize, edit, analyze, store, etc. the published content. The control element may also retrieve and use implied content and related content in performing the user selected action(s).

While local versions of the modified web page content may be stored at any of the client devices 821-823, content may also be stored remotely (e.g. in data stores 829) and updated as the original web page content changes. The platform providing the web page may store at and retrieve from data stores 829 directly or through database server 828 data associated with the web site (e.g. published, implied, or related content).

Network(s) 820 may comprise any topology of servers, clients, Internet service providers, and communication media. A system according to embodiments may have a static or dynamic topology. Network(s) 820 may include secure networks such as an enterprise network, an unsecure network such as a wireless open network, or the Internet. Network(s) 820 may also coordinate communication over other networks such as Public Switched Telephone Network (PSTN) or cellular networks. Furthermore, network(s) 820 may include short range wireless networks such as Bluetooth or similar ones. Network(s) 820 provide communication between the nodes described herein. By way of example, and not limitation, network(s) 820 may include wireless media such as acoustic, RF, infrared and other wireless media.

Many other configurations of computing devices, applications, data sources, and data distribution systems may be employed to implement web page behavior enhancement controls. Furthermore, the networked environments discussed in FIG. 8 are for illustration purposes only. Embodiments are not limited to the example applications, modules, or processes.

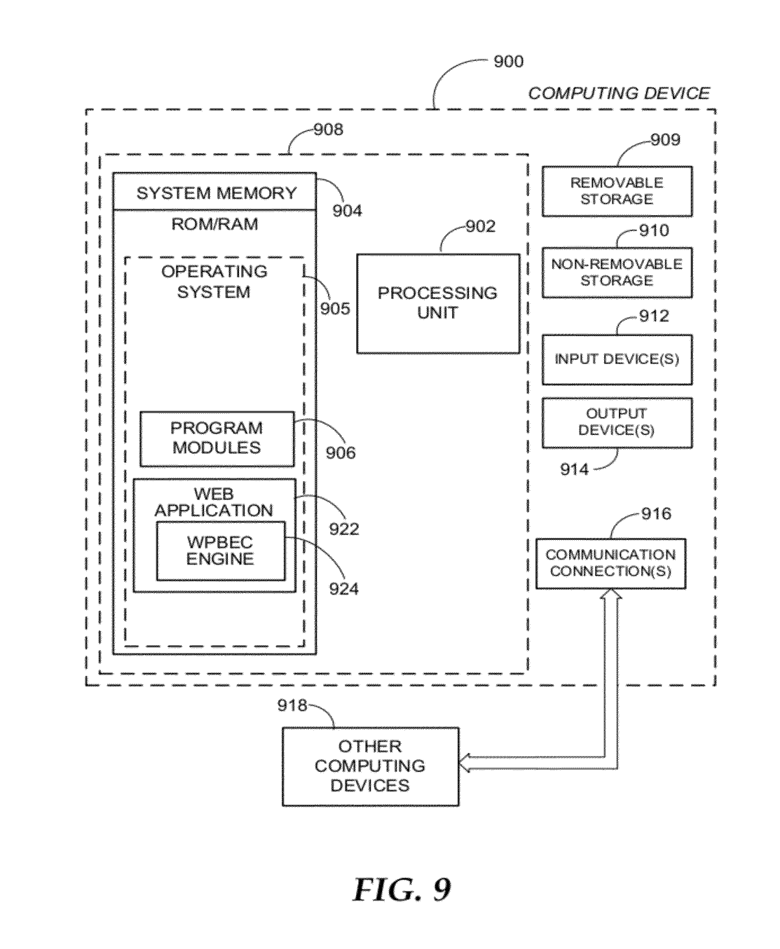

FIG. 9 and the associated discussion are intended to provide a brief, general description of a suitable computing environment in which embodiments may be implemented. With reference to FIG. 9, a block diagram of an example computing operating environment for an application according to embodiments is illustrated, such as computing device 900. In a basic configuration, computing device 900 may be a server executing an web application and include at least one processing unit 902 and system memory 904. Computing device 900 may also include a plurality of processing units that cooperate in executing programs. Depending on the exact configuration and type of computing device, the system memory 904 may be volatile (such as RAM), non-volatile (such as ROM, flash memory, etc.) or some combination of the two. System memory 904 typically includes an operating system 905 suitable for controlling the operation of the platform, such as the WINDOWS® operating systems from MICROSOFT CORPORATION of Redmond, Wash. The system memory 904 may also include one or more software applications such as program modules 906, web application 922, and WPBE control engine 924.

Web application 922 may be any application or service presenting textual, graphic, audio, video, and other data to users through their client browsing applications as web pages. Web application 922 may provide a WPBE control element embedded into a web page enabling users to perform various actions including enhancing web page content, storing the content locally, and tracking changes to the content through the WPBE control engine 924 as discussed previously. This basic configuration is illustrated in FIG. 9 by those components within dashed line 908.

Computing device 900 may have additional features or functionality. For example, the computing device 900 may also include additional data storage devices (removable and/or non-removable) such as, for example, magnetic disks, optical disks, or tape. Such additional storage is illustrated in FIG. 9 by removable storage 909 and non-removable storage 910. Computer readable storage media may include volatile and nonvolatile, removable and non-removable media implemented in any method or technology for storage of information, such as computer readable instructions, data structures, program modules, or other data. System memory 904, removable storage 909 and non-removable storage 910 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer readable storage media may be part of computing device 900. Computing device 900 may also have input device(s) 912 such as keyboard, mouse, pen, voice input device, touch input device, and comparable input devices. Output device(s) 914 such as a display, speakers, printer, and other types of output devices may also be included. These devices are well known in the art and need not be discussed at length here.

Computing device 900 may also contain communication connections 916 that allow the device to communicate with other devices 918, such as over a wireless network in a distributed computing environment, a satellite link, a cellular link, and comparable mechanisms. Other devices 918 may include computer device(s) that execute web services, analysis services, data storage services, and comparable devices. Communication connection(s) 916 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

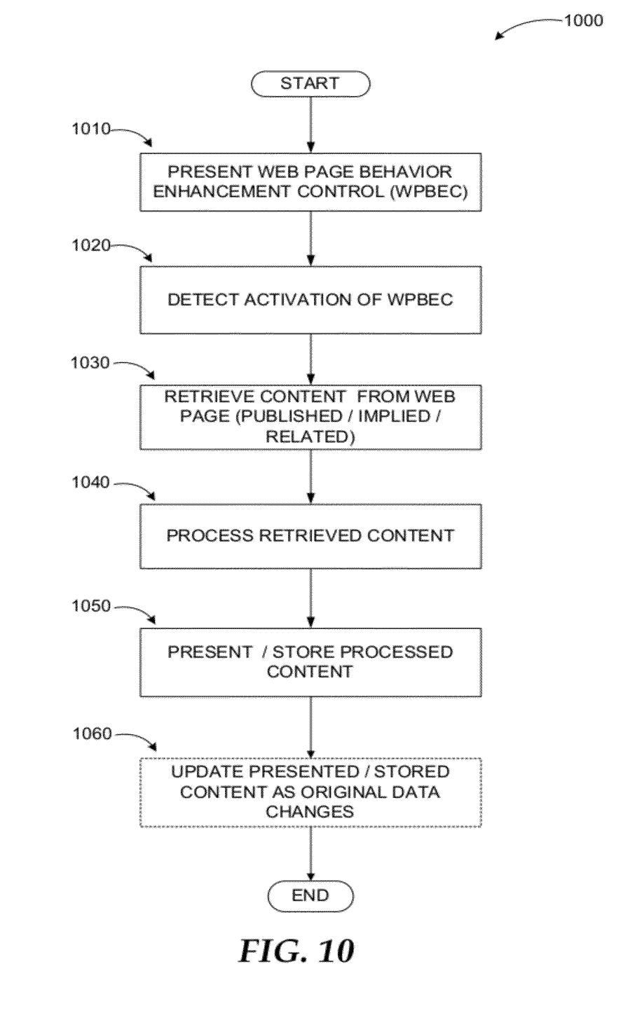

FIG. 10 illustrates a logic flow diagram for process 1000 of providing web page behavior enhancement controls according to embodiments. Process 1000 may be implemented by a WPBE control engine executed on a web server or client device.

Process 1000 begins with operation 1010, where the web page with a WPBE control element is presented. upon detecting activation of the WPBE control element at operation 102, content associated with the rendered web page may be retrieved at operation 1030. The retrieved content may include published content presented on the web page, implied content available but not presented on the web page, and/or related content from a data store associated with the rendered web page. The retrieved content may be processed based on a user indication received through the WPBE control element at operation 1040. The user indication may be received by presenting the user with a list of available actions such as customizing presentation of, performing an analysis on, editing, forwarding, annotating, and/or tracking the published, implied, and/or related content of the rendered web page.

The processed content may be presented the original rendered web page or a local version of the original rendered web page at operation 1050. Alternatively, the content may be stored and the stored content updated as content associated with the original rendered web page changes, and a notification associated with the updated stored content provided to the user at optional operation 1060.

Processing the content may include activating an application such as a word processing application, a spreadsheet application, a drawing application, a presentation application, or a browsing application, and presenting the processed content through a user interface of the activated application such that enhanced interaction with the content is enabled. One or more states of the WPBE control element may be persisted according to some embodiments such that user actions on a web page are presented to a user upon repeat visit of the same page. According to other embodiments, user actions from other users associated with the WPBE control element may be exposed to a user in form of suggestions.

The WPBE control engine performing the operations may be implemented as part of the server providing the web page or a client device executing a local browser rendering the web page. The WPBE control element may be associated with the entire rendered web page or one or more portions of the rendered web page. The WPBE control engine may retrieve the related content directly from a data source associated with the server directly without involvement of the web application, and notify the browser rendering the web page about changes to the published content and implied content. The WPBE control engine may also provide the list of available actions upon activation of the WPBE control element based on a capability of the browser rendering the web page, a capability of the web application, user preferences, and/or usage pattern(s).

The operations included in process 1000 are for illustration purposes. A web page behavior control according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A method executed at least in part in a computing device for providing web page behavior enhancement controls, the method comprising:
presenting a web page behavior enhancement (WPBE) control element on a rendered web page;
upon detecting activation of the WPBE control element retrieving content from the associated web application;
processing the retrieved content based on a user indication received through the WPBE control element; and
presenting the processed content in one of the original rendered web page and a local version of the original rendered web page.

2. The method of claim 1, further comprising:
storing the content;
updating the stored content as content associated with the original rendered web page changes; and
presenting a notification associated with the updated stored content.

3. The method of claim 1, wherein the content associated with the rendered web page includes at least one from a set of: published content presented on the web page, implied content available but not presented on the web page, and related content from a data store associated with the rendered web page.

4. The method of claim 1, further comprising:
activating an application; and
presenting the processed content through a user interface of the activated application such that enhanced interaction with the content is enabled.

5. The method of claim 1, wherein the application includes one of a word processing application, a spreadsheet application, a drawing application, a presentation application, a content aggregation application, and a browsing application.

6. The method of claim 1, further comprising:
persisting one or more states of the WPBE control element such that user actions on a web page are presented to a user upon repeat visit of the same page.

7. The method of claim 4, wherein the user actions include one or more of customizing presentation of the rendered content, performing an analysis on the rendered content, editing the rendered content, sharing the rendered content, exporting the rendered content, and tracking the rendered content.

8. The method of claim 1, further comprising:
exposing user actions from other users associated with the WPBE control element to a user in form of suggestions.

9. A server for providing web page behavior enhancement (WPBE) controls, the server comprising:
a memory;
a processor coupled to the memory, the processor executing a web application providing a web page with an embedded WPBE control element to be rendered by a browser and a WPBE control engine in conjunction with instructions stored in the memory, wherein the WPBE control engine is configured to:
upon detecting activation of the WPBE control element retrieve at least one from a set of: published content presented on the web page, implied content available but not presented on the web page, and related content from a data store associated with the rendered web page;
receive a selection for an action on the retrieved content, wherein the action is one of customize presentation of, perform an analysis on, edit, forward, and track at least one of the published, implied, and related content; and
perform the selected action processing the retrieved content.

10. The server of claim 9, wherein the WPBE control element is associated with one of the entire rendered web page and one or more portions of the rendered web page.

11. The server of claim 9, wherein the WPBE control engine is further configured to retrieve the related content directly from a data source associated with the server without involvement of the web application.

12. The server of claim 9, wherein the WPBE control engine is further configured to notify the browser rendering the web page about changes to the published content and implied content.

13. The server of claim 9, wherein the WPBE control engine is further configured to enable a user to one of customize, edit, and annotate the published content.

14. The server of claim 9, wherein the WPBE control engine is further configured to provide a list of available actions upon activation of the WPBE control element based on at least one of a capability of the browser rendering the web page and a capability of the web application.

15. A computer-readable storage medium with instructions stored thereon for providing web page behavior enhancement (WPBE) controls, the instructions comprising:
receiving published content associated with a web page from a server;
rendering the web page with an embedded WPBE control element;
upon detecting activation of the WPBE control element presenting a user with a list of available actions associated with the web page;
in response to receiving a selection, retrieving at least one of implied content available but not presented on the web page and related content from a data store associated with the rendered web page;
processing the retrieved content based on the selected action; and
performing one of:
presenting the processed content in one of the original rendered web page and a local version of the original rendered web page; and
storing the processed content such that the stored content is updated with changes to original content at the server.

16. The computer-readable storage medium of claim 15, wherein the WPBE control element is embedded into the web page at the local browser based on at least one of a capability of the browser and a usage pattern.

17. The computer-readable storage medium of claim 15, wherein the processed content is presented in one of a web application user interface, a local application user interface, and an embedded application user interface, the application being one of: a word processing application, a spreadsheet application, a drawing application, and a presentation application.

18. The computer-readable storage medium of claim 15, wherein a locally executed WPBE control engine retrieves the related content from the data store associated with the rendered web page directly.

19. The computer-readable storage medium of claim 18, wherein the WPBE control engine is configured to enable the user to at least one from a set of: customize presentation of, perform an analysis on, edit, share, export, annotate, and track at least one of the published, implied, and related content of the rendered web page.

20. The computer-readable storage medium of claim 15, wherein the instructions further comprise:
rendering the web page with a plurality of embedded WPBE control elements, each WPBE control element being associated with a portion of the rendered web page, and each WPBE control element providing a distinct set of available actions.
